(19) United States
(12) Patent Application Publication
(10) Pub. No.: US 2023/0306858 A1
(43) Pub. Date: Sep. 28, 2023

(54) SYSTEMS AND METHODS FOR ADMINISTERING SOCIAL EMOTIONAL LEARNING EXERCISES USING NARRATIVE MEDIA

(71) Applicant: AFFECTIFI INC., Brooklyn, NY (US)

(72) Inventors: Ilya Alex Lyashevsky, Maplewood, NJ (US); Melissa Marie Cesarano, Brooklyn, NY (US)

(21) Appl. No.: 18/033,765

(22) PCT Filed: Feb. 28, 2022
(86) PCT No.: PCT/US22/18118

§ 371 Date: Apr. 25, 2023

Related U.S. Application Data
(60) Provisional application No. 63/160,366, filed on Mar. 12, 2021.

(51) Int. Cl. G09B 5/00

(52) U.S. Cl. CPC G09B 5/00

(57) ABSTRACT

A computing device is provided for dynamically determining and/or automatically generating one or more social and emotional learning exercises associated with a media title selected by a user. The computing device has a communication interface for receiving a communication from a user device indicating the media title selected by the user and a processor for determining or generating one or more exercises corresponding with one or more mapped segments of the selected title based at least in part on a progress status of the user in an SEL curriculum. Upon determining or generating the one or more exercises corresponding with the mapped segments, the communication interface may send another communication to the user device indicating the one or more determined exercises such that the exercises may be administered to a user while watching the identified segments of the selected media title.

This application claims the benefit of U.S. Patent Application No. 63/160,366, filed Mar. 12, 2021, the disclosure of which is incorporated herein by reference.

### TECHNICAL FIELD

The present disclosure relates generally to the selection and administration of learning exercises, and more specifically, to systems and methods for administering social emotional learning exercises using narrative media.

### BACKGROUND

Social and emotional learning (SEL) is the process by which children and adults acquire and effectively apply the knowledge, attitudes, and skills necessary to understand and manage emotions, set and achieve positive goals, feel and show empathy for others, establish and maintain positive relationships, and make responsible decisions. Effective SEL learning can be important to an individual's development and sense of wellbeing. For example, skills such as emotional literacy, self-awareness, social awareness, empathy, relationship skills, decision making, and self-regulation have been shown to contribute to reductions in anxiety, reductions in depression, improved academic performance, higher graduation rates for students, and improved psychological and physical wellbeing. In the education context, SEL may be especially important for students to learn, understand, and effectively manage emotions and maintain positive relationships in a school environment. For instance, some students may face increased social and academic pressure while in school which in turn leads to greater stress, anxiety, and risk-taking, and research has shown that a large percentage of teenage students see anxiety and depression as a major concern. These problems have been further exacerbated by the COVID-19 pandemic which has necessitated at least some degree of remote schooling, and many educators are unprepared to implement SEL programming or manage the emotional toll of the classroom, contributing to poor learning outcomes for students and educator burnout.

Various solutions are known for teaching SEL skills to students and individuals alike, including training courses having a curriculum of set, pre-recorded narrative videos for illustrating social and emotional situations. However, these existing offerings suffer from several significant drawbacks that undermine their effectiveness for users. For example, the narrative content utilized in such training courses is typically limited, produced in-house, can be of poor quality, and may be viewed as inauthentic to users, thus reducing its effectiveness. In addition, various known solutions provide a curriculum with only a single path of progression and provide limited opportunities for individual learning on a personalized basis. For example, such known solutions include a step-by-step track of narrative content to watch, review, and respond to, without considering any preferences of, or information related to, the user. Similarly, such programs generally lack a sufficient amount of content for variability in ongoing SEL practice once the prepared curriculum has been completed. In the same vein, available solutions are not able to accurately assess user performance to provide any form of adaptive learning or training based on real-time assessment.

### BRIEF DESCRIPTION OF THE DRAWINGS

FIG. 1 is a schematic diagram of an example system for determining and administering one or more social and emotional learning exercises to a user using a social and emotional learning platform;

FIG. 2 is a schematic diagram of an example user device configured for use in connection with the system shown in FIG. 1;

FIG. 3 shows an example database for storing information associated with one or more users of a social emotional learning platform;

FIG. 4 shows an example database for storing information associated with mapped segments of one or more media titles including timestamps and emotional mapping information;

FIG. 5 shows an example database for storing exercises associated with mapped segments of one or more media titles;

FIG. 6 is a diagram showing an example method of determining and administering one or more exercises in social emotional learning curriculum corresponding with a media title selected by a user;

FIG. 7 is a flowchart showing an example method of generating one or more exercises for a user in a social emotional learning curriculum;

FIG. 8 is a flowchart showing an example method of generating and administering one or more exercises for a user in a social emotional learning curriculum;

FIG. 9 is a flowchart showing another example method of generating and administering one or more exercises for a user in a social emotional learning curriculum; and

FIG. 10 shows an example screenshot of a user interface for prompting a user to interact with one or more exercises associated with mapped segments of a selected media title.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted to facilitate a less obstructed view of the various embodiments. It will further be appreciated that certain actions and/or steps may be described or depicted in a particular order of occurrence while those skilled in the art will understand that such specificity with respect to sequence is not actually required.

### DETAILED DESCRIPTION

Generally speaking, pursuant to various embodiments, the systems, apparatuses and methods provided herein are useful to provide social and emotional learning tools associated with media content selectable by a user. In this manner, a user may self-select from a variety of available content and have exercises presented to the user based on, for example, the user's profile. In one illustrative approach, the generation of the exercises is done in real-time in light of content selection, user performance, and/or topics of interest or relevant to the curriculum. By some approaches, a user profile is updated in light of content selected or played and exercises presented and/or completed. Further, in some configurations feedback may be provided to the user in light of content reviewed and the exercises completed.

In accordance with one aspect of the present disclosure, a computing device is provided for determining and/or automatically generating one or more social and emotional learning exercises associated with a media title selected by a user. The computing device has a communication interface for receiving a communication from a user device indicating the media title selected by the user and a processor for determining or generating one or more exercises corresponding with the selected title based at least in part on a progress status of the user in an SEL curriculum. Upon determining or generating the one or more exercises, the communication interface may send another communication to the user device indicating the one or more determined exercises such that the exercises may be administered to a user while watching the selected media title. In some forms, the communication interface is further configured to receive yet another communication from the user device indicating the user's responses to the one or more exercises which may be stored in a database for subsequent analysis.

So configured, a user is permitted to select a media title for progressing through an SEL curriculum and the computing device is configured to dynamically determine one or more exercises corresponding with that media title based on the user's current progress. In some forms, the one or more exercises may be determined by the computing device (e.g., a remote server computer) based on one or more of a goal of the user, a preference of the user, a demographic of the user, and an emotional state of the user, among other factors. As such, the curriculum may be personalized for the user and tailored to a specific selected media title to provide a more engaging experience.

In some forms, the narrative media titles (e.g., a show, movie, audio narrative, text narrative, or other narrative media) may be selected by a user via a content provider or streaming service such as, for example, Netflix™, Hulu™, or Amazon Prime Video™, and the systems and methods of the present disclosure may be embodied as a downloadable program or software module such as a browser extension, software development kit (SDK), or an application programming interface (API) provided by an SEL platform or provider that, in some forms, may be configured to integrate or associate with the streaming service. In one non-limiting example, the user may download a browser extension or streaming service application that may utilize an API or SDK to provide the SEL curriculum and permit the user to select a media title to watch. In other examples, the streaming service may either be or include an SEL platform or provider such that a browser extension, API, or SDK need not be obtained from a separate SEL provider. Once the media title has been selected, the SEL software module on the user device may communicate the selection to a remote computing device (e.g., a server computer) and request one or more exercises associated with the selected title. The API may subsequently receive a communication indicating one or more exercises corresponding with the selected title and may be configured to prompt the user to complete the exercises at predetermined times during playback of the title. For example, the application may prompt the user to complete an exercise (e.g., a multiple choice question, true/false question, providing a narrative answer, etc.) after a specific segment of the title has been completed and receive the user's response.

In some forms, the accessible or downloadable program or software module from the SEL platform may be provided as a non-transitory computer readable medium that, when executed by a processor, causes performance of operations related to the administration of one or more exercises for a user participating in an SEL curriculum. For example, the program or software module (or a portion thereof) may be downloaded and installed on a user device such as a laptop, smartphone, tablet, and the like, and be executed by a processor of the device. The operations may include receiving a user input indicating a selected media title at a user interface of a user device and communicating a communication to a server computer indicating the selected media title. Further, the operations may include receiving another communication from the server computer indicating one or more exercises corresponding with the selected media title where each of the exercises are associated with a different segment of the media title. Additionally, the operations may include prompting the user to complete one or more exercises during a playback of the media title, and receiving a response to the one or more exercises.

In yet another aspect, a method for facilitating administration of one or more learning exercises includes receiving a communication from a user device that indicates a selected media title at a communication interface of a server computer. The method further includes the steps of determining or generating one or more exercises corresponding with the selected media title upon receiving the communication from the user device and communicating another communication to the user device indicating the one or more determined exercises to be administered to the user. Additionally, the method includes the steps of receiving one or more responses to the one or more exercises and updating a progress status of the user based on the received responses.

One beneficial aspect of the present systems and methods is the ability to engage in a variety of learning exercises and activities related to the emotions of characters the user may particularly enjoy based on their selection (e.g., in a favorite TV show or movie), which permits that user to engage with those characters on a deeper emotional level. As described herein, the exercises that are generated and presented to the users may relate to, or be associated with, a mental state of a character, an emotional state of a character, a psychological state of a character, a psychological trait of a character, a physiological state of a character, a physiological process of a character, a physical experience of the character, a personality trait of a character, or various other states, processes, or acts of a character in a narrative media title. In addition, such exercises may be administered to a user while watching media such as TV or film via existing streaming services, with no need to switch to a separate application or website. Similarly, use of the present systems and methods may provide certain psychological benefits to viewers and improve SEL education while still permitting the viewers to select the titles that they would prefer to watch.

Further, the present systems and methods can be used in a variety of settings, for example, therapeutic settings, business settings, and/or educational settings, such as primary and secondary schools as well as colleges to help students and educators improve social and emotional skills including emotional awareness, empathy, and self-regulation. Additionally, the systems and methods may be used by both institutions and individual consumers (e.g., parents purchasing a subscription to an SEL platform or provider for their children) for the same purpose. In further forms, it could also be used in the context of corporate wellness, corporate leadership training, and corporate compliance, with company employees using the invention to improve their emotional knowledge, their social skills, and their understanding of issues like sexual harassment. Furthermore, the present systems and methods could be used in a clinical context, where therapists or other mental health practitioners recommend or prescribe the solution to their patients as an additional resource for building their emotional knowledge and resilience.

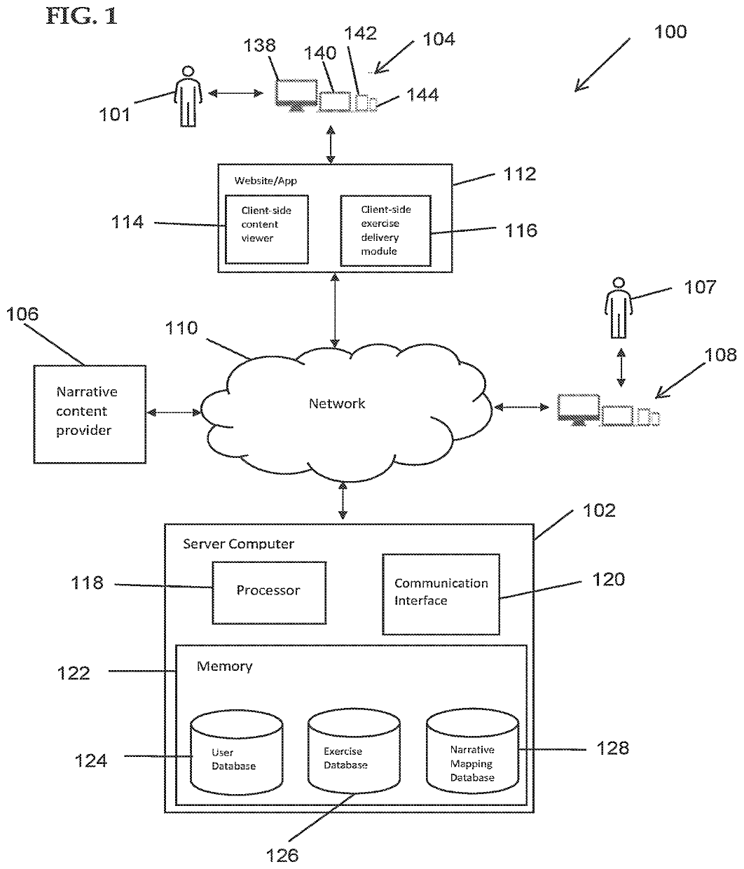

Referring now to the drawings, and more particularly FIG. 1, an example system 100 for generating and administering one or more social and emotional learning exercises to a user 101 is shown including a computing device in the form of a server computer 102, a user device 104 (e.g., a desktop computer 138, laptop 140, tablet 142, smart TV (not shown), or smartphone 144), a narrative content provider 106 (e.g., a streaming platform or other content provider), and an SEL platform device 108 that are all configured to communicate with one another either directly or indirectly through a network 110, such as the internet.

As shown in one illustrative approach, the user device 104 is configured to interface with or access a website or application 112 having a client-side content viewer 114 for viewing narrative media content and a client-side exercise delivery module 116 for administering one or more exercises to the user 101 within a curriculum provided by an SEL platform (e.g., as implemented on server computer 102) that may, or may not, be directly integrated with the viewer 114. In some forms, the client-side exercise delivery module 116 may be downloaded by a user from an SEL platform and stored locally on the user device 104, and in other forms, the exercise delivery module 116 may be integrated with the client-side content view 114 by the narrative content provider 106. In one example, the website or application 112 may be a website associated with a streaming platform, such as Netflix.com, and the website may communicate with a narrative content provider 106 such as Netflix™, to receive selected narrative media content via the network 110. As discussed in further detail below, the exercise delivery module 116 may be at least partially integrated with the website or application 112 as a browser extension, custom code communicating with an API, or SDK, and may be configured to receive one or more exercises for the user 101 generated or determined by the server computer 102. So configured, a user 101 may access the website or application 112 via the user device 104 for consuming selected narrative media content obtained from the narrative content provider 106, and the exercise delivery module 116 may prompt the user to respond to one or more exercises associated with the media content. In the context of the present disclosure, media content should be understood to include any form of narrative media such as a television show, movie, streaming title, audio narrative content, text narrative content, or any portions thereof.

As illustrated, the server computer 102 includes a processor 118, a communication interface 120, and a memory 122 having one or more databases such as a user database 124 for storing information associated with users, an exercise and curriculum database 126 for storing one or more exercises associated with different media titles, and a narrative mapping database 128 for storing information related to “segments” (e.g., scenes or sub-portions) of selected narrative media titles, in some forms, the databases 124, 126, 128 may alternatively be formed as a single database or may instead be implemented in a distributed manner as shown. Further, although the databases 124, 126, 128 are shown as being integrated with the server computer 102, such databases may be external to the server computer 102 and communicatively coupled thereto such that the server computer 102 may retrieve information therefrom. The databases 124, 126, 128, which can be accessed by the processor 118, typically include one or more processor-readable and/or computer-readable media and can include volatile and/or nonvolatile media, such as RAM, ROM, EEPROM, flash memory and/or other memory technology. The databases 124, 126, 128 can be substantially any relevant memory form and may in some forms be distributed at multiple locations over a computer network, such as network 110. In some forms, the information stored in the databases 124, 126, 128 may be input by user 101 via the user device 104 or an SEL provider 107 via the SEL device 108.

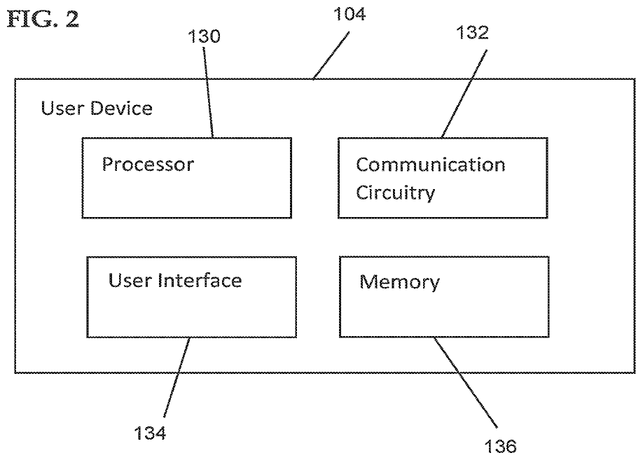

Referring now to FIG. 2, an example user device 104 is shown including a processor 130, communication circuitry 132, a user interface 134, and a memory 136. As explained above, the user device 104 may be any device configured to access and/or interface with the website or application 112 to view one or more selected narrative media titles and may be a desktop computer 138, laptop 140, tablet 142, or smartphone 144 (FIG. 1). The processor 130 may be any known type of processor such as a microprocessor, microcontroller, embedded processor, digital signal processor, and the like. In some forms, the communication circuitry 132 may operate via one or more known wireless communication protocols and may be connected to the network 110 via a Wi-Fi connection or a cellular network. Via the communication circuitry 132, the user device 104 may be configured to access one or more websites, such as a streaming website for watching narrative media content. The memory 136, which can be accessed by the processor 130, typically includes one or more processor-readable and/or computer-readable media and can include volatile and/or nonvolatile media, such as RAM, ROM, EEPROM, flash memory and/or other memory technology. In some forms, the application 112 (FIG. 1) and/or training delivery module 116 comprises computer program code that is configured to be installed on (e.g., in the memory 136) and executed by the user device 104.

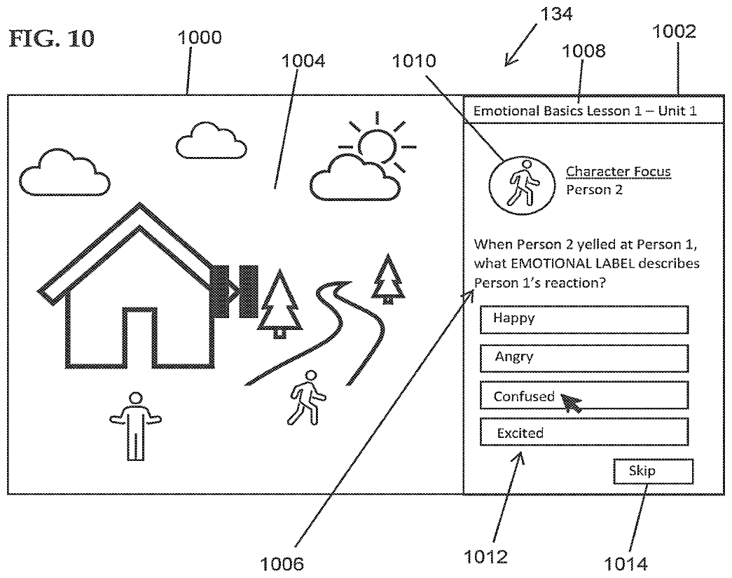

In some examples (such as described with respect to FIG. 10 below), the client-side exercise delivery module for administering one or more exercises and receiving responses thereto may be integrated or associated with a streaming application and may be implemented as an overlay or extension of the screen for viewing the narrative media title. For example, the user may interact with the exercise delivery module and view the narrative media on the same screen (e.g., the user interface of the user device 104). In alternative forms, the functionality of the user device 104 for administering one or more exercises associated with a narrative media title to the user may be split among two or more devices. For example, the client-side exercise delivery module may alternatively be installed or accessed on a user's smartphone or tablet and the narrative media associated with the exercises may be shown to a user via a smart TV or other secondary screen such as a separate monitor or computer screen. To facilitate the administration of exercises to the user, the user's smartphone or tablet may be synchronized with the smart TV or other screen such that upon reaching an identified segment of the media title as displayed to the user, the user's smartphone or tablet may be configured to notify or prompt the user to respond to one or more exercises associated with that specific segment of the media title (e.g., via a mobile application). So configured, a smart TV maker, SEL provider, or other entity may provide a mobile application that is configured to integrate with or access the client-side exercise delivery module 116 and enable synchronization with the media title being shown on the secondary screen for administering exercises associated with segments at proper times (e.g., upon reaching the end of a segment). Such embodiments would thus not require an overlay or separate window that may inadvertently cover or otherwise obscure a portion of the narrative media title being viewed by a user.

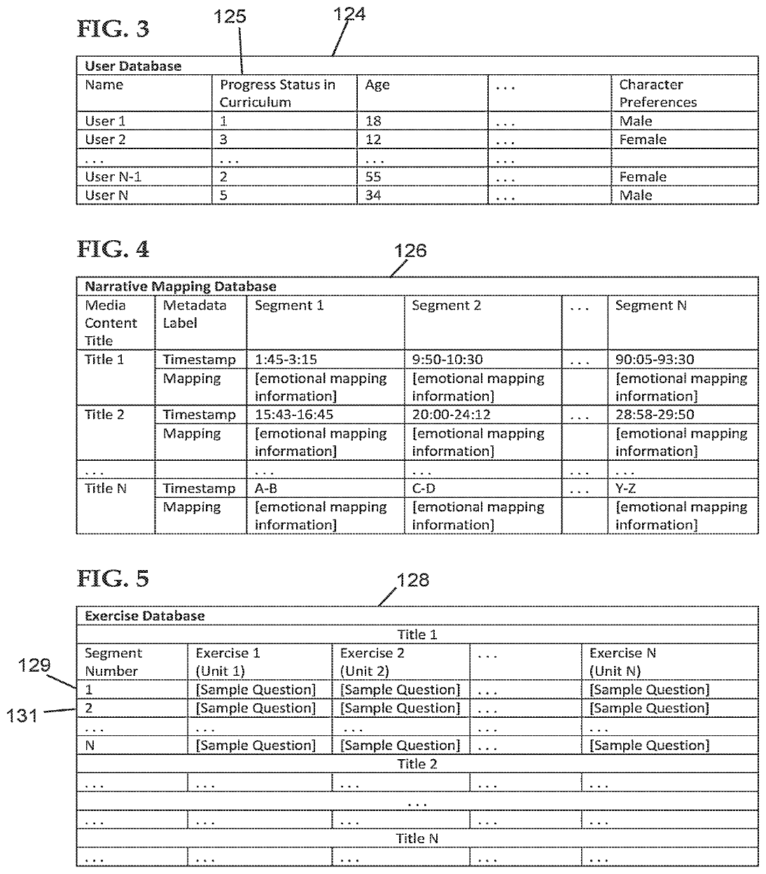

Referring now to FIGS. 3-5, the example databases 124, 126, 128 associated with the server computer 102 are shown in further detail, In some forms, the information stored in the databases 124, 126, 128 may be utilized by the processor 118 of the server computer 102 to generate or determine exercises for a user shortly before and/or while the user is watching a selected narrative media title (e.g., a streaming show or movie) as described in further detail below.

As shown in FIG. 3, the user database 124 may include various information associated with an individual user of an SEL platform as administered by the exercise delivery module 116. Such information stored in database 124 may be used to generate or determine one or more selected exercises for the user based on a selected media title. As illustrated, the database 124 may include information such as the user's name, a progress status of the user (e.g., what unit stage of the SEL curriculum the user has reached and/or frequency of program use), an age, and character preferences (e.g., a specific character, a general type of character, or character traits). By one approach, the progress status, illustrated in column 125, is represented by a simplistic numerical incrementation for ease of illustration, however, it should be understood that the progress status may, represent any number of units, sub-units, or individual lessons completed by the user. In another approach, the progress status may indicate a timing of the completed lessons or exercises. In addition, although not illustrated, the database 124 may further include a variety of other information associated with each user, such as responses of the user to previously administered exercises, favorite shows or movies, gender, an interest in one or more topics (e.g., race, romance, relationships, religion, etc.), and other similar information. Such information may be received, for example, by a user inputting certain information in the user device 104 or by administering one or more exercises via the exercise delivery module 116 and receiving responses thereto.

As shown in FIG. 5, the narrative mapping database 126 may include information related to a “mapping” or “emotion mapping” of individual segments for a plurality of different media titles (e.g., shows, movies, etc.). For example, individual segments of a number of different media titles may be “mapped” by identifying portions thereof that contain character interactions which may be useful for emotion skill training, determining or identifying the characters involved in the interactions within the segment, determining timestamps associated with those segments, and storing information related to the perceived underlying psychological data of the character(s) in that segment. For each of the mapped segments, underlying psychological data pertaining to the characters' experiences within the segment may be identified based on emotion science constructs and principles.

In some embodiments this mapping may be performed manually by an SEL provider 107 entering information related to a segment of a media title via device 108 (FIG. 1). For example, the SEL provider 107 may identify data related to the segment based at, least in part on appraisal theory, which involves the evaluation of incoming stimuli based on their goal-congruence—in other words, whether the stimuli align with an individual's goals, desires, and needs. As such, the mapping process by the SEL provider 107 may involve assessment of a character's potential appraisal of an event that occurs in the segment, as well as one or more of the goals, desires, and needs that are relevant to the appraisal, and whether the event is congruent or not congruent with those goals, desires and needs. In addition, the mapping process may involve the identification of potential appraisals, goals, desires, and so on, that would likely be false or irrelevant for the character in question given the context of the situation. Such information identified during the mapping process may be communicated to the server computer 102 for storage in database 126. As understood herein, all or parts of this process to identify particular segments and assess and enter the appraisal structure of the character's experience within a particular segment may be referred to “mapping,” and a “mapped segment” should be understood to refer to a portion of a media selection including associated information related to the perceived underlying psychological data of the character(s) in that segment. In some forms, the mapping of each segment of the media titles may enable automatic generation of exercises for a user as described in further detail below Indeed, the segment mapping may provide for automatic generation of exercises for multiple users with different abilities, skill levels, and other SEL knowledge. For example, a beginning user watching a given scene from a selected media title may be presented different exercises as compared to a more advanced or skilled user watching the same scene from the selected media title, as described below.

In connection with the mapping process, the segments may be tagged with metadata such as timestamps associated with each of the segments (e.g., a beginning time, an ending time, or both), tags indicating topics that the segments may relate to (e.g., family, romance, race, a type of event, etc.), names of characters present in the segment and related information such as a character status (e.g., major, minor, etc.), and a ranking based on the perceived complexity of the emotions experienced by the characters in the segment. Some or all of the segment metadata may be manually entered by the SEL provider manually input based on a perception of the provider) or automatically generated by the processor 118. For example, the processor 118 may be configured to automatically identify and tag information such as the timestamps, or may further identify and tag names of characters that are present within a segment based on known methods such as facial recognition such that those names are included in the segment metadata. The metadata related to each of the segments may be stored in the database 126 for subsequent use in generating exercises related to those segments to users. For example, in some forms, it may be beneficial to provide users with exercises based on one or more preferences of the user, which may include specific topics the user enjoys (e.g., romance) or a selected character, such that tagged segments related to those topics or characters can be selected for a specific user.

As illustrated, each of the media titles may be of any length and a specific media title need not include any specific number of segments. In an example where the media title is an episode of a show having a shorter length or includes very few social or emotional situations to assess, only a small number of segments (e.g., 1 or 2) may be mapped for generating exercises for a user. However, in an example where the media title is longer, such as a movie, or if it includes a large number of social or emotional situations to assess, that media title may have a larger number of mapped segments for generating exercises that may be administered to a user.

As shown in FIG. 5, the exercise database 128 may include any number of exercises related to any number of mapped segments for a given narrative media title. In some forms the exercises may be automatically generated by the processor 118 of the server computer 102 based at east in part on the segment mapping as described in further detail below, or may be manually created by the SEL provider 107 and entered into the database 128. As illustrated, each media title (e.g., “Title 1”) includes a specific number of segments as mapped by the SEL provider 107 and stored in the narrative mapping database 126. Each mapped segment for each media title may include one or more exercises corresponding with that segment (e.g., questions related to the social and emotional content within that scene or sub-portion of the media title). For example, if mapped segment 129 of Title 1 depicts a marriage proposal between two individuals, one exercise may include a question for the user asking “Which emotional response most accurately characterizes character 1's response to the proposal” with various potential answers such as “happy,” “sad,” “angry,” and the like. In some forms, the exercises may be manually created by the SEL provider 107 based on the content within the segment and then stored in the database 126 for subsequent retrieval to be administered to a user. However, in other forms, the exercises may be dynamically generated by the server computer 102 for each user on a personalized basis as described in further detail below. In such embodiments, the exercises generated by the server computer 102 may or may not be stored in the exercise database 126. In alternative forms, the exercise database 126 may include a listing of the exercises that have been previously dynamically generated by the server computer 102 and administered to a user, including responses of the user thereto.

In some embodiments, the SEL curriculum that may be administered to a user may be broken up into individual units or sections, and the exercises presented or administered to a user within those units or sections may be based at least in part on a user's progress through the curriculum, concepts the user has already covered in the curriculum, and past performance on various different exercises. Each mapped segment may include multiple different exercises as shown in database 128, and some exercises may be associated with a “progress” or “unit” within the curriculum (e.g., “Unit 1,” “Unit 2,” etc.) such that the difficulty of the exercises may scale with a progress of the user. So configured, this may permit a user at any unit in the SEL curriculum to encounter segments and exercises corresponding with their current progress status thus enabling a more personalized experience. For example, a first user that is just beginning the curriculum that watches segment 131 of title 1 may receive a more simplistic question related to the characters' social and emotional responses (e.g., Exercise 1 which may be associated with a first unit of the curriculum), and a second user that is further along in the curriculum watching the same segment may receive a more advanced question related to the same character related to their goal appraisal (e.g., Exercise 2 which may be associated with a second unit of the curriculum). As described in further detail below, the processor 118 of the server computer 102 may consider the user's progress status through the curriculum to determine and select which exercises, either determined or generated by the server computer 102, should be provided to the user.

In some forms, the structure of or units presented in an SEL curriculum may vary for different users. For instance, different versions of the curriculum may include different units or sub-sections depending on a user's demographic, or personal or professional domains of interest, such that the target skills within the curriculum may be more relatable or useful for an individual in a similar position to learn. For example, there may be one specific curriculum tailored to high-school or college students with target skills directed to situations those students are more likely to encounter, and another specific curriculum tailored to adults or parents with different target skills. So configured different versions of curriculums may be selected for different users which may be based on information input by those users (e.g., preferences, demographic information, etc.).

Additionally or alternatively, each segment may include multiple potential exercises configured to target different skills, include different potential exercise types, and may focus on a specific character within a segment. For example, in some forms the exercises related to a specific segment may include questions related to multiple different characters in the scene or multiple different reactions of those characters. A segment including two different characters interacting (e.g., a male character and a female character) may include exercises related to either one or both of the characters' perspectives which may be different and may target different skills. In still further forms, a longer segment may include multiple unique interactions between different characters such that exercises may be determined related to each unique interaction from each character's perspective. So configured, each segment of each narrative media title may include a plurality of potential exercises for a user to test a variety of different social and emotional skills.

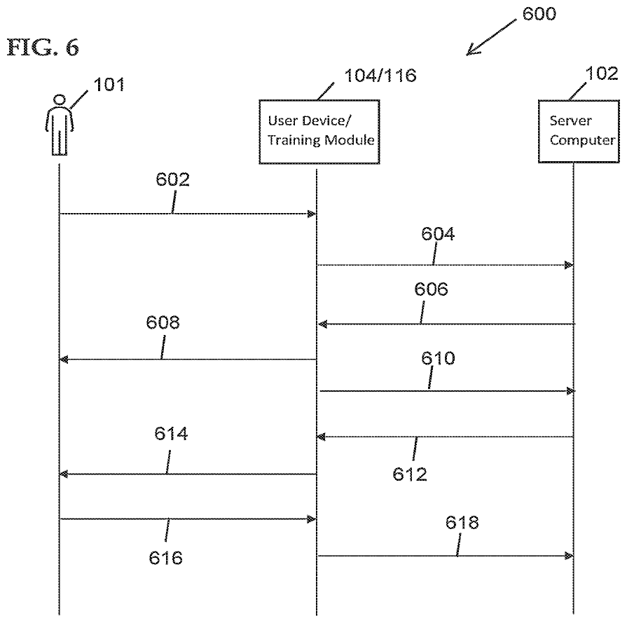

Referring now to FIG. 6, an example method 600 for administering one or more exercises for a user participating in an SEL curriculum is described. In one form, the user 101 may interact with the user interface 134 (FIG. 2.) of the user device 104 to navigate to the website or application 112 of a selected streaming service when the user desires to watch a selected media title (e.g., Breaking Bad, Season 4, Episode 1). In some forms, one or more media titles may be recommended to a user based at least in part on user preferences, a user's progress in the curriculum, or other factors. For example, if the user has progressed to a unit of the curriculum addressing a specific target skill, the exercise delivery module 116 may recommend a narrative media title that includes example segments that may relate to or be used to test that target skill. Upon selection of the media title via the user interface 134 (line 602), the exercise delivery module 116 of the app/website 112 may communicate, via the communication circuitry 132 of the user device 104, a first communication in the form of a request (line 604) to the server computer 102 to retrieve video segment metadata associated with the selected media title (e.g., timestamps or other associated information related to scenes or sub-portions of the title) that may be stored in the narrative mapping database 126.

Upon the server computer 102 receiving the request, the processor 118 may be configured to identify one or more mapped segments of the media title based on one or a combination of current learning goals of the user, progress within an SEL curriculum, past performance on one or more exercises, character preferences, demographic information, an emotional state, other preferences of a user, or other factors as described further below. In one example related to the emotional state of the user, if the user has indicated that they are particularly happy, angry, or sad, the processor 118 may be configured to identify at least one segment of the media title including a character demonstrating that emotional response for the user to identify with. In another example, if present in the selected media title, the processor 118 may be configured to identify at least one segment of the media title that relates to a current or past event that the user has indicated interest in (e.g., if a user has indicated that they are interested in a certain past event such as World War II, the processor 118 may attempt to select a segment related to that event if present in the selected media title). The processor 118 may be configured to compile a listing of the one or more mapped segments of the media title, including associated metadata as retrieved from database 128, and communicate the listing of the one or more segments to the exercise delivery module 116 via the user device 104 (line 606). In some forms, upon receiving the listing of the one or more segments, the listing of mapped segments may be presented to the user 101 within the website or application 112, for example, via a browser extension or as integrated directly into the website or application 112 (line 608). In one form, the listing may be presented to the user in an overlay or additional window that identifies the mapped segments by a brief description (e.g., scene name or description of events occurring during the segment) and may further include associated metadata such as the timestamps corresponding with those segments.

In some embodiments, the listing of segments for a selected media title may be updated or re-fetched from the server computer 102 based on the progress of a user within the SEL curriculum. For example, upon the server computer 102 receiving one or more responses to exercises completed by the user, the progress of the user in the SEL curriculum may be updated such as by updating the user's information stored in the database 124. If the user has advanced to a new unit or sub-section of a unit, and the user continues watching the same media title, the processor 118 may be configured to update or create a new listing of segments for the user involving or enabling the application, or testing, of the target skills or concepts in the new unit and cause communication of the updated listing to the exercise delivery module 116 via the user device 104.

The exercise delivery module 116 of the app/website 112 may additionally communicate, via the communication circuitry 132 of the user device 104, a request to the server computer 102 via the network 110 to obtain one or more exercises associated with each of the mapped segments (line 610). In some forms, this request may occur in connection with the first communication (line 604) such that only a single communication is sent to the server computer 102 upon selection of the media title to request both the listing of segments and the exercises associated with those segments or may alternatively occur at a separate time. In one embodiment, upon the user reaching the end of a segment of the media title as identified and returned by the server computer 102 (e.g., based on a timestamp associated with the segment), the exercise delivery module 116 of the app/website 112 may communicate, via the communication circuitry 132 of the user device 104, the request to server computer 102 to obtain one or more exercises associated with the current segment for displaying to a user (line 610). In some forms, the request may be made earlier such as when a beginning of the segment is reached by the user.

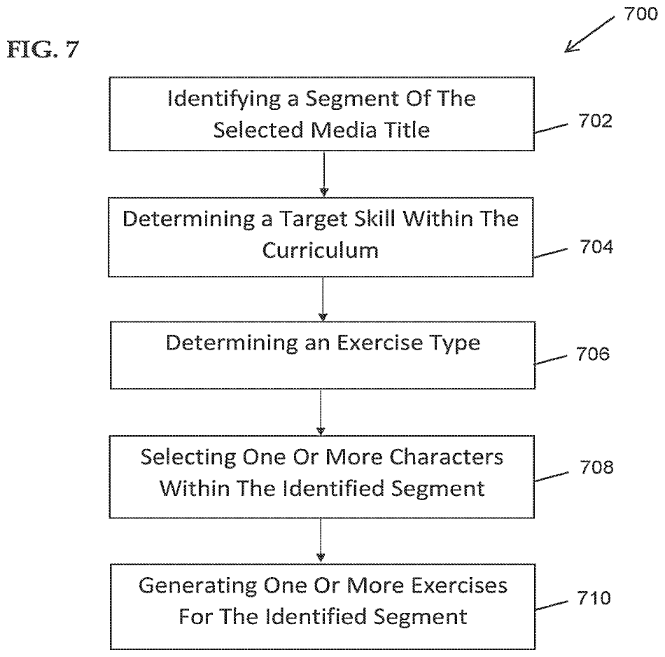

When the communication in the form of the exercise request is received by the communication interface 120 of the server computer 102, the processor 118 may be configured to either dynamically generate one or more exercises for the user corresponding with the mapped segments of the selected media title or select from among a set of manually entered or previously generated exercises. In some forms, the dynamic generation of exercises may be automatically performed by the processor 118 based on a target skill to be tested, a type of exercise, and a focus character within a selected segment (See FIG. 7). In some embodiments, the exercises generated by the processor 118 may relate to or be associated with a mental state of a character, an emotional state of a character, a psychological state of a character, a psychological trait of a character, a physiological state of a character, a physiological process of a character, a physical experience of the character, a personality trait of a character, or various other states, processes, or acts of a character in the selected media title. The dynamic generation of exercise also may be automatically performed, in part, based on information in the user database.

To dynamically generate the one or more exercises, the processor 118 may first determine a target skill within the curriculum to be tested for the user who has selected the media title. For example, there are numerous potential target skills that may be tested based on emotion science principles, including but not limited to emotion valence identification, appraisal and appraisal goal congruence identification, belief identification, hedonic motive identification, among others. In some forms, the processor 118 may determine the target skill to be tested based on one or a combination of current learning goals of the user, a progress status of the user within an SEL curriculum (e.g., a unit level, etc.), past performance on one or more exercises, character preferences, demographic information, an emotional state of the user, or other factors. The processor 118 may initially determine a user's progress status within the SEL curriculum based at least in part on the information stored in the user database 124 and select a target skill to be tested based on the user's current progress. For example, if the user is on unit 4 of the curriculum, which may be focused on identifying character goals, the processor 118 may be configured to select target skills for the mapped segments that specifically relate to identification of character goals as opposed to target skills associated with other units that the user has already completed. In contrast, if a user is on a lower unit of the curriculum which may be focused on skills related to identification of emotional responses, the processor 118 may be configured to generate exercises for the mapped segments that specifically relate to those target skills.

In other examples, the selection of the target skill to test for generating the one or more exercises may be based on past performance of the user in the curriculum, such as being based on responses to one or more previously administered exercises. For instance, the user may have progressed through a certain portion of the curriculum but may have performed poorly on an individual exercise or unit of exercises related to a specific target skill or topic, and the processor 118 may be configured to generate exercises that may relate to the prior topic the user struggled with. Additionally or alternatively, for a user that has completed the curriculum but still wishes to receive additional exercises while watching media titles (e.g., to continue their practice with SEL concepts), the target skills the processor 118 may select for generating exercises may similarly be determined based on the user's past performance on exercises related to those target skills. For example, if the user covered the concept of appraisal within the curriculum but performed relatively poorly on exercises targeting skills related to appraisal, exercises specifically related to appraisal may be selected and/or generated by the processor 118 in an effort to further improve the user's skills.

Additionally, the processor 118 is configured to determine a specific exercise type (e.g., multiple choice, true or false, etc.) related to the target skill selected for the mapped segment. Such a determination may be based on, for example, a preference of the user (e.g., a user has indicated they prefer a certain exercise type), past performance (e.g., a user has historically performed poorly on a certain exercise type), among other factors.

During the exercise generation process, the processor 118 is further configured to select one or more characters within the segment exhibiting a social or emotional response as the subject of the exercise to test the target skill. In some forms, the selection of the character for the exercise may be based at least in part on certain preferences or interests of the user, learning goals of the user, certain known demographic characteristics of the user, an emotional state of the user, a “theme” or topic of the unit if the theme or topic is related to sexual orientation, an LGBTQ+ character in the media title may be selected), or the relative importance of the character (e.g., major, minor, supporting, etc.). For example, if the user has indicated a preference for exercises related to male characters (e.g., as stored in the user database 124), the processor 118 may be configured to select a male character's emotional reaction as the subject of the exercise. Similarly, if the user has indicated an interest in racial issues, the processor 118 may be configured to select an African American character's emotional reaction for one or more of the exercises. Further, if the demographic information of the user is known (e.g., the user is a younger Asian woman), to the extent the same or a similar demographic is represented in an individual segment, the processor 118 may be configured to select the emotional reaction of an individual having the same or similar demographic for the exercise which may represent a social or emotional situation the user has personally encountered or can identify with. So configured, the character(s) selected as a subject of the exercise may be personalized and tailored to a user's preferences, interests, learning goals, or demographics, among other features. Additionally or alternatively, the processor 118 may also select a character to be the focus of an exercise based at least in part on a user's past performance level. For example, the processor 118 may be configured to select a character that exhibits either a more complex emotional reaction if the user has performed well or a less complex emotional reaction if the user has performed poorly. Still further, the character may be selected based on the extent to which the character's reaction has been “mapped.” For example, one character's reaction may be “mapped” more fully than another character's in the same scene, and as such the former character's “mapping” can be utilized for testing some skills that the latter character's less complete “mapping” may not support.

The processor 118 may then be configured to generate one or more exercises for the user based at least in part on the target skill to be tested, the type of exercise, the selected character in the segment, and the socio-emotional mapping of the segment (e.g., as performed by the SEL provider 107). For example, if the target skill is selected as identifying; the character's potential goals and the exercise type is selected as multiple choice, the processor 118 may be configured to select true and false goals as manually input by the SEL provider 107 during the segment mapping to generate various permutations of exercises in which only one response from the user may be correct, more than one response from the user may be correct, all responses from the user may be correct, or no responses from the user may be correct. In such an example, the exercise generated by the processor 118 may be a multiple-choice question asking “what are the goals of [character 1] in this scene” and the potential answers for the user to select may include various true or false goals that were input during the segment mapping by the SEL provider 107. So configured, the exercises may be dynamically generated and individually tailored to a user participating in the curriculum and a user may be permitted to select any available media title regardless of their progress within a curriculum while still receiving exercises that are uniquely generated based on, for example, their progress status, preferences, and other factors.

In some forms, the processor 118 may be configured to consider a variety of other factors in generating or determining the one or more exercises for the user such as a time since the user last engaged with the program. For example, if the user has not interacted with the program or completed any exercises in a predetermined period of time (e.g., 2 weeks, 1 months, 3 months, etc.) the processor 118 may be configured to generate or determine one or more review exercises to re-test prior concepts to determine whether the user has retained the skills covered in prior units or whether the user should restart or otherwise rework through a portion or all of the curriculum. Such information related to times of user engagement may be stored in the user database 124.

Additionally or alternatively, the processor 118 may be configured to select static learning content to be presented to a user that may be unrelated to the selected media title or its mapped segments. For example, the static learning content may be related to a user's progress within the curriculum and may include one or more instructional items or one or more self-check or review exercises. In some forms, a specific instructional slide or set of slides may be presented to a user at the beginning of a unit of the curriculum to generally explain the concepts or target skills that the user will be tested on. In other forms, one or more review exercises to test certain concepts or target skills may be presented to a user after a certain threshold number of exercises have been completed, after a unit or level of the curriculum has been completed, before or after an exercise is administered to a user, or at random intervals to assess user progress. Such exercises may be more general questions that test the user's familiarity with social and emotional principles, or may be directed to hypothetical situations. This static learning content may be communicated back to the user device 104 along with information indicative of the exercises to administer.

Still further, the processor 118 may be configured to select or generate feedback associated with the exercises for displaying to a user before, during, or after a user has responded to the exercises. Such feedback may be based on the mapping of the segment as performed by the SEL provider and may provide useful information to the user including but not limited to reasons why certain answers are correct, reasons why certain answers are incorrect, goals of the characters within the scene, and the like. Any feedback associated with the determined exercises may be communicated back to the user device 104 along with information indicative of the exercises to administer.

Once the exercises have been dynamically generated or selected from among a set of manually created exercises, the processor 118 is configured to cause the communication interface to send a communication back to the exercise delivery module 116 via the user device 104 (line 612) indicative of the one or more determined exercises to facilitate display of the exercises to the user within the website or application 112. While the user is watching the media title, the playback may be paused either directly or indirectly by the exercise delivery module 116 upon reaching the end of an identified segment and the exercises may be presented to the user within the website or application 112 via the user interface of the user device 104 (line 614). In other forms, the media title may not be paused and may keep playing in the background while a user completes an exercise. In still other forms, such as where the narrative media title may not be a video and may alternatively include narrative text, there may be no need to “pause” the media title. As explained above, the exercises may include multiple-choice questions, short answer questions, or the like, and may relate to one or more social or emotional experiences that occurred during the segment. The user 101 may then respond to or skip the one or more exercises by interacting with the user interface of the user device 104 (line 616). As described above, the user may likewise be presented with static learning content such as instructional slides, review exercises, or feedback related to the exercises completed by the user. The user's response and/or progress within the curriculum may be stored locally by the training module 116 or may additionally or alternatively be communicated by the user device 104 to the server computer 102 (line 618).

Upon receiving the user's response, the processor 1.18 of the server computer 102 may be configured to store the response or information indicative of the response (e.g., an indication of whether the user was correct or incorrect) in one or more of the databases, such as database 124 and/or database 126, which may in turn be used to generate subsequent exercises for the user.

Once the user has completed an exercise (e.g., by providing a response), the playback of the media title may be resumed either directly or indirectly by the exercise training module 116 and the above-described process may be repeated when the next mapped segment in the list of segments is reached during the playback.

In some embodiments, the user may be permitted to manually navigate to or select individual segments in the listing of segments to engage with instead of watching the media title passively and encountering segments at predetermined times. For example, links associated with the identified segments may be provided to a user such that the user may select a link for a specific segment and engage in the one or more exercises associated with that segment (e.g., the segment may begin playing for the user, and upon reaching the end of the segment, one or more exercises may be presented to the user). In addition, the user may be presented the option to “skip” or fast-forward from one segment to the next in a sequential manner such that the user does not need to watch the portions of the media title that have not been mapped or do not have any associated exercises or activities. In this manner, the user may select a media title and progress through each segment as individual video clips to complete exercises and advance through the curriculum.

In still other embodiments, a user may be permitted to select a specific unit of the curriculum or skill within the curriculum to engage with rather than passively following the curriculum while watching one or more media titles. For example, if the user desires to revisit a unit or target skill that was previously covered or attempt to learn a new unit or skill, the user may select that unit or skill from a menu on the user interface 134 on the user device 104 and be presented with one or more segments having exercises related to that skill (e.g., as dynamically generated by the server computer 102 or as selected from a list of predetermined questions such as those stored in database 126). In some forms, the server computer 102 may generate or determine a listing of mapped segments based on the user's selection of a specific unit of the curriculum and the listing of mapped segments may include segments from a plurality of different media titles for the user to watch and engage with (e.g., different episodes of the same series, different movies, different shows). So configured, the user may engage with these different narrative segments sequentially and engage with exercises associated with those segments. Although the individual segments within the segment list may be from a plurality of different media titles, the segments and exercises associated therewith may be unified in a theme based on a selection of the user (e.g., if the user desires to learn more about the emotion of “anger,” the segments from each media title may involve scenes where an individual exhibits an angered response).

Referring now to FIG. 7, an example method 700 of dynamically generating one or more exercises for a mapped segment of a media title is shown. The one or more exercises may be generated by a server computer upon receiving a communication indicating a selected media title, and the exercises may be generated to correspond with that selected media title. In other approaches, the exercises may be generated by the user device itself or in communication with the server computer by, for example, receiving information stored in one or more databases associated with the server computer.

In step 702, once a media title has been selected, the method as shown includes identifying one or more mapped segments of the media tide, which may be performed by server computer 102. In some forms, the identified segments may include all segments that have been mapped for a specific media title or may alternatively include less than all mapped segments. In some embodiments, the identified segments may be selected based on one or a combination of current learning goals of the user, progress within an SEL curriculum, past performance on one or more exercises, character preferences, demographic information, or other factors. For example, in a media title such as “Mad Men,” a user may have indicated a character preference for the main character “Don Draper.” As a result, mapped segments including that character may be identified and selected. The method 700 may additionally include the steps of compiling a list of the identified segments and communicating the list of identified segments to a user device (not shown).

In step 704, the method 700 includes determining a target skill within an SEL curriculum to be tested using the one or more exercises. As explained above, there may be a number of potential target skills to test that are based on emotion science principles, including but not limited to emotion valence identification, appraisal and appraisal goal congruence identification, belief identification, and hedonic motive identification. The target skill may be determined based on one or a combination of current learning goals of the user, progress status within an SEL curriculum (e.g., a unit of the curriculum), past performance on one or more exercises, character preferences, demographic information, or other factors, as already described in further detail above with respect to FIG. 6.

In step 706, the method 700 includes determining an exercise type for the one or more exercises which may be based on, for example, a preference of the user (e.g., a user has indicated that they prefer a certain exercise type), past performance (e.g., a user has historically performed poorly on a certain exercise type), among other factors. Example question types may include true or false questions, multiple choice questions, ordering questions (e.g., to order potential responses in ascending or descending order), short answer questions, matching questions, among others. The exercise type may also be set in the metadata of e.g., the unit or curriculum that the user is currently on.

In step 708, the method 700 further includes selecting or determining one or more characters within the identified segments) to be the subject of the exercise to test the target skill. In some forms, the selection of the character for the exercise may be based at least in part on certain preferences or interests of the user, learning goals of the user, character significance within the narrative media title, certain known demographic characteristics of the user, or the extent of the character's emotional “mapping”, as described in further detail above with respect to FIG. 6.

In step 710, the method 700 includes generating one or more exercises for the identified segment to be administered to a user. As discussed above, this may be based at least in part on the target skill to be tested, the type of exercise, the selected character in the segment, and the emotion mapping of the segment. In one example where the user may be at an early or basic unit in the curriculum, the determined target skill for the user's Level may relate to determining a basic emotional response of a character. Once the target skills, exercise type, and character for the exercise have been determined, the exercise may be generated based on the emotion mapping of the segment previously performed and stored in a database (e.g., narrative mapping database 126).

So configured, the exercises may be generated based on the target skill, exercise type, and selected character, each of which may vary significantly for each user based on the factors described above, to provide a significant number of exercise permutations to administer to users. As a result, each user may progress through the curriculum by selecting any media title they prefer to watch, and based on their progress, preferences, and other known information, may be provided with individualized questions at their current progress level and relating to topics or characters they may identify with. Each user may thus complete the curriculum watching any number of different media titles, in any order, while still being presented with exercises testing the same social and emotional concepts resulting in a dynamically personalized curriculum.

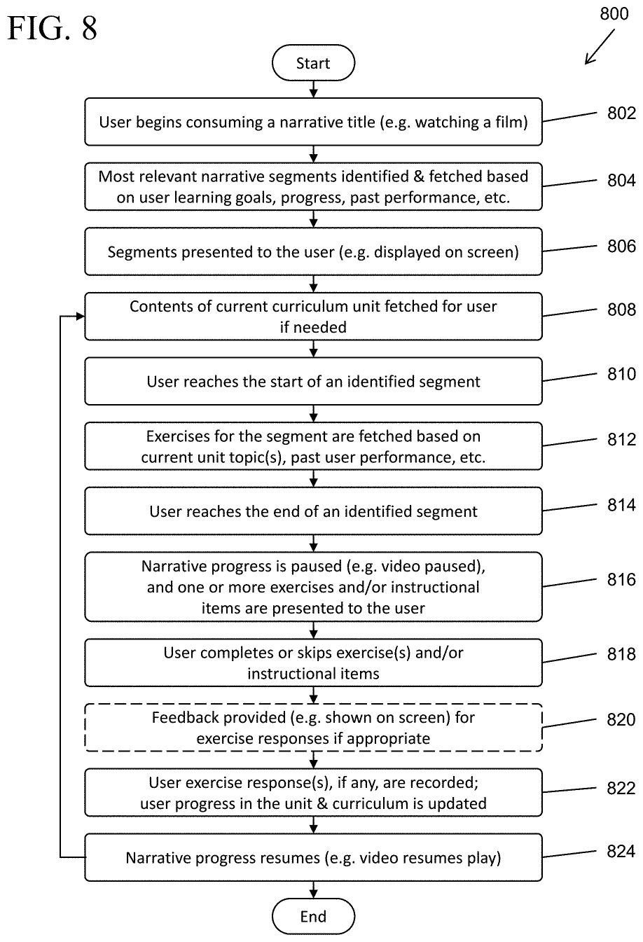

Referring now to FIG. 8, another example method 800 of administering one or more exercises within an SEL curriculum to a user during playback of a selected media title (e.g., via a streaming service) is shown. At step 802, the method includes a user selecting and beginning to watch a narrative media title such as a movie or episode of a show. Once the media title has been selected, at step 804, relevant mapped narrative segments of the media title are identified and retrieved (e.g., from a database) based at least in part on learning goals of a user, a progress status within an SEL curriculum, past performance in the curriculum, among other factors. Next, at step 806, the mapped segments that have been identified and retrieved may be presented to the user in the form of an ordered list. At step 808, or earlier (e.g., in step 804) the contents of the current curriculum unit (e.g., the target skills to test the user on depending on the user's progress and additional learning content related to the skills and concepts covered in the unit) may be retrieved if needed from a database such as the user database 124. While the user is watching the media title, in step 810, the user reaches the beginning of a mapped segment that has been identified in step 804. Once the user has reached the beginning of the mapped segment, at step 812, one or more exercises associated with that segment may be requested and retrieved from a server computer that is configured to dynamically generate the one or more exercises based on one or a combination of current unit topics in the curriculum, past user performance, among other factors such as described with respect to FIG. 7. Although method 800 depicts step 812 as occurring upon the user reaching the start of an identified mapped segment, it should be understood that the request and retrieval of the one or more exercises may alternatively occur upon selection of a media title (step 802), when the mapped segments are identified (step 804), or when the user reaches the end of the identified segment (step 814 below).

When the user reaches the end of an identified segment at step 814, the media title is paused and the one or more exercises that were retrieved and/or one or more instructional items may be presented to a user in step 816. Once a user completes or skips the one or more exercises and/or instructional items in step 818, in some embodiments, feedback may be provided to the user related to the one or more exercises and/or instructional items in step 820. In some forms, the feedback may be provided immediately after completion of an exercise, and in other forms, may be provided upon completion of the selected media title. Next, in step 822, responses of the user to the one or more exercises may be recorded (e.g., in a database associated with a server computer) and the user's progress in the current unit being tested and the overall curriculum may be updated. In step 824, playback of the media title is resumed, and the user continues to watch the media title until encountering another identified segment or manually navigating to that segment at which point one or more of steps 808-824 may be repeated until each identified mapped segment of the media title has been completed or the user stops engaging with or viewing the narrative media title.

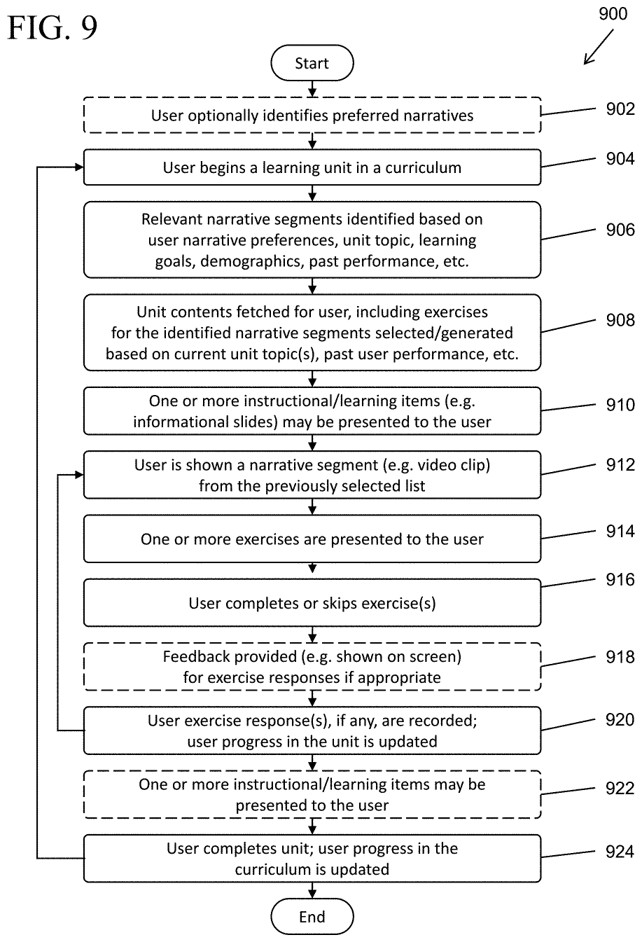

Referring now to FIG. 9, another example method 900 of administering one or more exercises within an SEL curriculum to a user is shown which may be implemented on a standalone website as opposed to being integrated with an existing streaming service or other narrative media provider. In contrast with method 800 explained above, method 900 need not occur during playback of a selected media title and may instead be configured to present the user with one or more video clips from one or more media titles to progress through an SEL curriculum in a lesson-by-lesson or step-by-step basis as described in further detail below. First, in step 902, the user may optionally identify one or more preferred narrative media titles to be used for generating one or more exercises for the user within the SEL curriculum. For example, if the user were to select the show “The Sopranos” and/or the “Star Wars” movies, various exercises may be generated for the user based on mapped segments within those media titles to create a more personalized experience. Alternatively, if the user declines to select one or more preferred media titles (e.g., if the user does not have a preference or does not care), the exercises generated for the user may either be selected from a predetermined list or may be randomly generated based on any number of potential media titles. As explained above, the curriculum may be broken up into a number of individual units or levels that may relate to a specific skill or grouping of skills within the SEL curriculum. In some embodiments, the units of the curriculum will increase in difficulty (e.g., based on complexity of concepts) as the user progresses through various segments. At step 904, the user begins a specific learning unit within the SEL curriculum and at step 906 relevant mapped segments of one or more media titles are identified based on one or a combination of user preferences (e.g., as input by a user in step 902), unit topic (e.g., some segments may only include more/less complex social emotional situations that may not be appropriate for a user's current unit level), learning goals (e.g., if a user specifically desires to focus on one or more target skills or topics such as “parenting”), demographics of the user, or past performance, among others.

At step 908, exercises for the identified mapped segments may be generated or selected in the manner described above with respect to FIG. 6. For example, the exercises may be automatically generated by the server computer as described above or may be selected from a pre-generated or predetermined (e.g., manually entered) listing of exercises corresponding with the segments of the selected media title.

Optionally, at step 910, one or more instructional or learning items such as informational slides may be presented to the user. For example, before presenting the user with a segment from a media title and administering an exercise, it may be beneficial to present the user with one or more instructional slides explaining the concepts or target skills that the user will be tested on in the upcoming segment. If the user is in a unit of the curriculum concerning goal evaluation, the user may be presented with one or more interactive slides that explain the general concept of goal evaluation and may provide basic examples for the user to understand.

At step 912, the user may then be presented with a mapped segment from the media title as identified in step 906 in the form of a video clip, and in step 914, one or more exercises as generated or selected in step 908 may be presented to the user. In step 916, the user may complete or optionally skip the exercises, and in optional step 918 feedback may be provided to the user based at least in part on the user's response similar to the embodiments described above. Once the user has responded, in step 920, the user's responses may be recorded and the user's progress status through the unit and/or the overall curriculum may be updated. If additional identified segments remain that have not yet been shown to the user, the method 900 may then return to step 912 to present the user with yet another mapped segment such that the user may be tested with additional exercises related to that segment.

Optionally, in step 922, once the user has progressed through each of the mapped segments that have been identified for the current unit or unit section the user is progressing through, one or more instructional or learning items such as informational slides may be presented to the user to summarize or recap the concepts that the user has learned throughout the exercises administered in steps 912-920. However, such instructional or learning items may also be presented to a user at other times, such as before or after an exercise has been administered. Finally, in step 924, the user has completed the unit and the user progress in the curriculum may be updated. Thereafter, the method 900 may return to step 904 to administer a different unit of the curriculum to the user for learning one or more new target skills. In some embodiments, the method 900 may continue until the user has completed each unit within the curriculum. The user may desire to continue learning or practicing SEL concepts after the curriculum has been completed and may manually select various units to repeat, and in some forms, may select new media titles to be tested on to vary the social and emotional experiences that the user may be presented with. So configured, the user may continue to be presented with exercises and combinations of exercises related to skills they have previously covered in the curriculum.

FIG. 10 illustrates an example screenshot 1000 of the user interface 134 of a user device 104 showing an overlay 1002 of an exercise delivery module integrated with a website or application 1004 associated with a streaming service, such as Netflix™, and further showing an example exercise 1006 being administered to a user. A media title (e.g., a television show or movie) has been selected by a user and is being streamed via the website or application 1004 so the user can view the same. The example overlay 1002 associated with the exercise delivery module may be provided on a lateral extent of the user interface 134, or other portions of the interface, and is configured to be interacted with by the user for progressing through an SEL curriculum. The overlay 1002 may include, for example, a current lesson or unit 1008 the user is progressing through, a specific character 1010 being focused on in a scene, and one or more exercises or prompts 1006 for the user depending on whether certain segments of the media title have been mapped by the curriculum provider.

As depicted in the screenshot, playback of the media title has been paused in this embodiment, and the overlay 1002 of the exercise delivery module has prompted the user on the user interface 134 to respond to an exercise 1006 (e.g., that may have been generated by the server computer 102 in the manner described above). Once the user has completed the exercise 1006 by either selecting one of the available options 1012, or alternatively clicking the “Skip” option 1014, the playback of the media title may resume, and the user may continue to watch until the next mapped segment including one or more exercises is encountered.

Although the present systems and methods are described in the context of a social and emotional learning curriculum, it should be understood that the systems and methods may similarly be useful for administering any form of curriculum to one or more users. For example, the dynamic exercise generation to personalize the learning experience for each user may likewise be applied in other subjects or concepts to be taught to one or more users.

Uses of singular terms such as “a,” and “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments, it will be appreciated that numerous changes and modifications will occur to those skilled in the art, and it is intended for the present disclosure to cover all those changes and modifications.

1. A computing device comprising:
a memory having one or more databases;
a communication interface configured to receive a first communication from a user device associated with a user account, the first communication being indicative of a preexisting media title selected for playback;
a processor operably coupled to the communication interface, wherein the processor is configured to determine an identity of the media title from the first communication and determine one or more exercises for interactive presentation in relation to the playback, the determination of the one or more exercises being made at least in part on the identity of the media title and a progress status associated with the user account in the one or more databases;
wherein the interactive presentation of the one or more exercises includes electronic display of one or more question prompts relating to content of the media title and solicitation of one or more user input responses to the one or more question prompts;
wherein the processor is configured to cause the communication interface to communicate a second communication to the user device, the second communication being indicative of the one or more exercises; and
wherein the communication interface is configured to receive a third communication from the user device, the third communication being indicative of the one or more user input responses to the one or more exercises, and wherein the processor is configured to store the one or more responses in the one or more databases.

2. The computing device of claim 1, wherein the progress status associated with the user is determined based at least in part on one or more previous user input responses of the user to one or more previous exercises stored in the one or more databases.

3. The computing device of claim 1, wherein the processor is further configured to determine the one or more exercises at least in part on one or a combination of:
a selected target skill associated with the user account in the one or more databases;
a selected target concept associated with the user account in the one or more databases;
a selected goal associated with the user account in the one or more databases;
a selected preference associated with the user account in the one or more databases;
a demographic datapoint associated with the user account in the one or more databases; and
an identified emotional state associated with the user account in the one or more databases.

4. The computing device of claim 3, wherein the communication interface is further configured to receive a signal from the user device indicating one or more of the selected target skill, the selected target concept, the selected goal, the selected preference, the demographic datapoint, and the identified emotional state.

5. The computing device of claim 1, wherein the one or more exercises are associated with identified segments of the media title, and wherein the second communication includes one or more timestamps associated with the identified segments.

6. The computing device of claim 1, wherein the one or more question prompts relating to content of the media title are formulated at least in part from data stored in the one or more databases, the data documenting one or a combination of:
a mental state of a character presented in the media title;
a mental process of a character presented in the media title;
an emotional state of a character presented in the media title;
a psychological state of a character presented in the media title;
a psychological trait of a character presented in the media title;
a physiological state of a character presented in the media title;
a physiological process of a character presented in the media title;
a personality trait of a character presented in the media title;
a physical experience of a character presented in the media title; and
an act of a character presented in the media title.

7. The computing device of claim 1, wherein the one or more exercises are unique to the media title.

8. The computing device of claim 1, wherein the progress status is determined relative to a curriculum associated with the user account in the one or more databases.

9. The computing device of claim 1, wherein a plurality of exercises associated with a plurality of media titles are stored in the one or more databases, and wherein the one or more exercises are determined by the processor based on the plurality of exercises stored in the one or more databases.

10. The computing device of claim 1, wherein the processor dynamically generates the one or more exercises at least in part on one of a target skill, past performance data, a target concept, and/or demographic data associated with the user account in the one or more databases.

11. A non-transitory computer readable medium having instructions stored thereon that, when executed by a processor, cause the processor to perform operations related to administration of one or more exercises, the operations comprising:
at a user device:
receiving, at a user interface of the user device, a user input indicating selection of a preexisting media title for playback;
communicating, by communication circuitry of the user device, a first communication to a remote server computer, the first communication being indicative of the media title;
receiving, at the communication circuitry, a second communication indicative of one or more exercises as determined by the remote server computer based at least in part on an identity of the media title determined from the first communication, each of the one or more exercises associated with a respective segment of the media title and including one or more question prompts relating to content of the respective segment of the media title and solicitations of one or more user input responses to the one or more question prompts;
displaying, on the user interface during playback of the media title, the one or more question prompts and the solicitations of the one or more user input responses; and
receiving, via the user interface, the one or more user input responses.

12. The non-transitory computer readable medium of claim 11, wherein the displaying of the one or more question prompts and the solicitations of the one or more user input responses associated with the respective segment of the media title occurs upon completion of the respective segment of the media title.

13. (canceled)

14. The non-transitory computer readable medium of claim 11, wherein the non-transitory computer readable medium further comprises instructions that when executed define a browser extension configured to interface with a streaming service application that provides the media title.

15. The non-transitory computer readable medium of claim 11, wherein the operations further comprise receiving, from the remote server computer, information indicative of feedback for display on the user based at least in part on the one or more user input responses.

16. A method for facilitating administration of one or more exercises, the method comprising:
receiving, at a communication interface of a remote server computer, a first communication from a user device associated with a user account, the first communication being indicative of a preexisting media title selected for playback;
determining, at a processor of the remote server computer, an identity of the media title form the first communication;
determining, at the processor of the remote server computer, one or more exercises for interactive presentation in relation to the playback, wherein the determining of the one or more exercises is based at least in part on the identity of the media title and a progress status relative to a curriculum assigned to the user account in one or more databases and wherein the interactive presentation of the one or more exercises includes electronic display of one or more question prompts relating to content of the media title and solicitation of one or more user input responses to the one or more question prompts;
communicating a second communication to the user device, the second communication indicative of the one or more exercises;
receiving, at the communication interface, a third communication indicative of the one or more user input responses to the one or more question prompts; and
updating the progress status based at least in part on the one or more user input responses indicated by the third communication.

17. The method of claim 16, wherein the determining of the one or more exercises is further based at least in part on a predefined user preference stored in the one or more databases.

18. The method of claim 16, wherein the determining of the one or more exercises further includes generating the one or more exercises based on one or a combination of a selected target skill associated with the user account in the one or more databases, a selected exercise type associated with the user account in the one or more databases, and a selection, associated with the user account in the one or more databases, of a character that appears in the media title.

19. (canceled)

20. The method of claim 16, further comprising identifying one or more segments of the media title, and wherein each of the one or more exercises are associated with at least one of the one or more segments.

21. The method of claim 20, wherein the second communication further includes a listing of the one or more segments.

22. (canceled)

23. The non-transitory computer readable medium of claim 11, wherein the non-transitory computer readable medium further comprises instructions that when executed synchronize the displaying of the one or more question prompts and the solicitations of the one or more user input responses with a playback device that provides the media title, the playback device being separate from the user device
